(19) United States
(12) Patent Application Publication
(10) Pub. No.: US 2002/0087637 A1
(43) Pub. Date: Jul. 4, 2002

(54) Component information database system and search method thereof

(76) Inventors: Haruhiko Banno, Akishima-shi (JP); Yuuichi Kitagawa, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/026,621

(22) Filed: Dec. 27, 2001

(30) Foreign Application Priority Data
Dec. 27, 2000 (JP) 2000-398095

(51) Int. Cl. G06F 15/16

(52) U.S. Cl. 709/205

(57) ABSTRACT

In this invention, at least one of a plurality of kinds of information which include a component code, manufacturer model number, and risk information associated with a component, and pertain to the component is input to acquire a plurality of pieces of information which are found by searching a plurality of databases on the basis of the at least one input information that pertains to the component, and pertain to the component such as a component code, manufacturer model number, risk information associated with the component, and the like.

### CROSS-REFERENCE TO RELATED APPLICATIONS

This application is based upon and claims the benefit of priority from the prior Japanese Patent Application No. 2000-398095, filed Dec. 27, 2000, the entire contents of which are incorporated herein by reference.

### BACKGROUND OF THE INVENTION

1. Field of the Invention

The present invention relates to a component information database system for searching information that pertains to a component, and its search method.

2. Description of the Related Art

Conventionally, a component information data system is used to design components. Component attribute information stored in this component information data system normally mainly includes characteristic values such as specifications, CAD design information such as footprints, or manufacture technique information used to mount components on a board, but no risk information represented by information that pertains to intellectual properties of components, a condition of time for delivery in the material department and a condition of volume of production in the manufacturing department are stored.

In a conventional database system, information link methods between various data systems and search systems have one-to-one correspondence, and a plurality of databases cannot undergo a simultaneous search. For this reason, in order to search a plurality of databases, a different search system must be launched for each search.

If component information database systems used in an intra-company LAN are taken as an example, a component information database of a design-assist system used in a design department and that of a material-assist system used in a material department are independently accessed, and do not share any information.

Furthermore, conventionally, dedicated search systems are required to search various databases. For this reason, when the user wants to, e.g., search for a component or investigate a patent during layout design of PCB-CAD, he or she must launch a search system in addition to a design tool.

Furthermore, a search result of a conventional component database system is normally information that specifies a component, such as a component code, manufacturer model number, or the like, but the intellectual property unique to a component and a list of suitable EDA libraries are not reflected in a search result.

More specifically, in the conventional database system, terms (e.g., connector, memory, box connector, DRAM, SDRAM, and the like) which are to be used in a search are hierarchically designated to obtain information that pertains to a component.

However, the conventional component information database system suffers the following problems.

Since the conventional component information database system does not store any risk information that pertains to components such as information of intellectual properties, investigation of another's intellectual property requires a very long time until a component having an intellectual property is specified and invasion of another's rights is evaded, since related references must be acquired from the Patent Office. For this reason, since it is hard to investigate intellectual properties in a component adoption stage, components must be changed, or infringement of rights is found after components are adopted.

Since information link methods between a plurality of databases that store component information and search systems have one-to-one correspondence, different search systems must be launched for each search to search a plurality of databases.

Furthermore, when the user wants to search for a component or to investigate intellectual properties during component design using CAD, he or she must launch a search system in addition to a design tool.

Furthermore, since the intellectual property unique to a component and a list of suitable EDA libraries are not reflected in a search result, a designer must individually search databases that store required information.

### BRIEF SUMMARY OF THE INVENTION

The present invention has been made in consideration of the above situation, and has as its object to provide a component database system which provides risk information such as intellectual properties (patent rights, design rights), a condition of time for delivery in the material department and a condition of volume of production in the manufacturing department and the like to components to be registered in a component information database, and allows reference to detailed information of risk information such as intellectual properties of respective components as images, so as to evade invasion of another's rights and prevent troubles in a component adoption stage, and its search method.

It is another object of the present invention to provide a component information database system which can simultaneously acquire and display information by associating a plurality of pieces of information which are stored in a plurality of databases and pertain to components, and its search method.

It is still another object of the present invention to provide a CAD system obtained by adding the component information database system to a design tool.

It is still another object of the present invention to provide a component information data system which can simultaneously display information associated with a component that the user wants to search for by only inputting information that pertains to the component upon searching for component information.

Therefore, in order to achieve the above objects, the first aspect of the present invention is a search method of a component information database system, comprising: inputting at least one of component information that include a component code, manufacturer model number, and risk information associated with a given component and a retrieve condition of the component information to be retrieved; retrieving component information including a component code, manufacturer model number, and risk information associated with a given component from a plurality of data bases based on the input component information; extracting component information which match the retrieve condition from the retrieved component information including a component code, manufacturer model number, and risk information associated with a given component; and displaying the extracted component information including the risk information.

According to this invention, by inputting at least one information that pertains to a component, all pieces of information associated with the components as well as risk information can be acquired, thus evading invasion of another's rights and preventing troubles in a component adoption stage.

In the above invention, when a user designates the displayed risk information, information indicating a presence/absence of pertinent intellectual properties acquired for the designated component may be displayed on the basis of the plurality of kinds of information which are found by searching the plurality of databases and pertain to the component.

Furthermore, when the user designates the displayed information indicating the presence/absence of pertinent intellectual properties, information indicating types of intellectual properties acquired for the designated component may be displayed on the basis of the plurality of kinds of information which are found by searching the plurality of databases and pertain to the component, and when the user designates the displayed information indicating types of intellectual properties, an image indicating contents of an intellectual property corresponding to the designated information indicating the types of intellectual properties may be displayed on the basis of the plurality of kinds of information which are found by searching the plurality of databases and pertain to the component.

With this invention, since the user can visibly and quickly recognize intellectual property information of a component, the load on the user upon component adoption can be reduced.

Furthermore, upon displaying risk information, information indicating if a self-company application has been filed, and another's right information may be displayed in addition to information indicating the presence/absence of an pertinent intellectual property. In this case, self-company application information and another's right information are assigned their respective levels.

By assigning levels to information, many kinds of information can be provided to the user, thus reducing the load on the user upon component adoption.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the overall component information database system according to an embodiment of the present invention;

FIG. 2 is a functional block diagram of a client computer of the database system of the embodiment;

FIG. 3 is a functional block diagram of a server computer of the database system of the embodiment;

FIG. 4 shows data stored in a design department component information database 5a;

FIG. 5 shows data stored in a material department component information database 5b;

FIG. 6 shows data stored in a production department component information database 5c;

FIG. 7 shows data stored in basic data database 5d;

FIG. 8 is a view for explaining risk information associated with the design department;

FIG. 9 shows levels of the presence/absence of a self-company application;

FIG. 10 shows levels of another's right information;

FIG. 11 is a view for explaining risk information associated with the material department;

FIG. 12 is a view for explaining levels of trouble information;

FIG. 13 shows levels of an organization associated with quality;

FIG. 14 is a diagram for explaining a case wherein a filter function is provided to a component information simultaneous search unit;

FIG. 15 is a flow chart for explaining the operation of a component information database system;

FIG. 16 is a flow chart for explaining the operation of a simultaneous search of component information in step S4 in detail;

FIG. 17 is a flow chart for explaining a process after information that pertains to a component and is output from the server computer is received by a design department client computer;

FIG. 18 shows a display screen displayed on a display of the design department client computer;

FIG. 19 shows the types of EDA data;

FIG. 20 shows risk information;

FIG. 21 shows intellectual property information acquired for a component;

FIG. 22 shows an image of intellectual property information;

FIG. 23 shows a flowchart for explaining the operation of the database system according to another embodiment of the present invention;

FIG. 24 shows an extracted component information; and

FIG. 25 shows a display of weighted component information.

### DETAILED DESCRIPTION OF THE INVENTION

A component information database system according to an embodiment of the present invention will be described below with reference to the accompanying drawings.

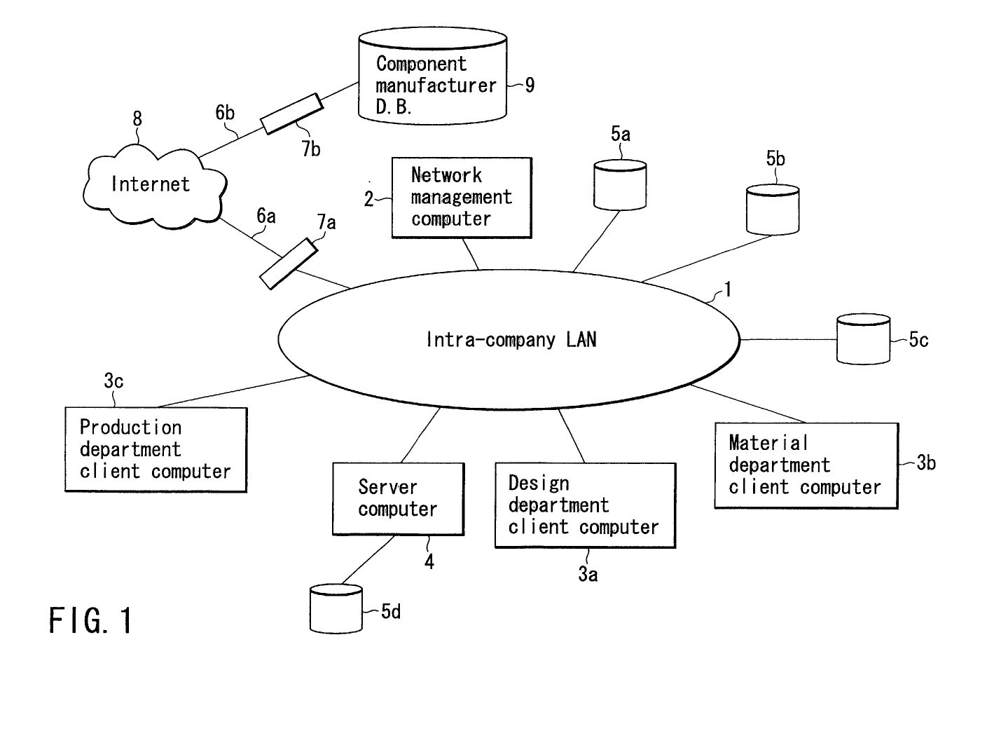

FIG. 1 shows the overall component information database system according to an embodiment of the present invention.

As shown in FIG. 1, in a component information database system of this embodiment, a network management computer 2, design department client computer 3a, material department client computer 3b, production department client computer 3c, server computer 4, design department component information database 5a, material department database 5b, and production department database 5c are connected to an intra-company LAN 1.

The server computer 4 also has a basic data database 5d for storing basic data of components.

In FIG. 1, the databases 5a to 5c connected to the intra-company LAN 1, and the basic data database 5d provided to the server computer 4 are exemplified as databases. Also, databases may be provided to client computers, and their locations are not particularly limited.

The intra-company LAN 1 is connected to a component manufacturer database 9 that stores basic information of components of a given component manufacturer via a firewall 7a, public line 6a, Internet 8, public line 6b, and firewall 7b.

The network management computer 2 manages the overall intra-company LAN 1, and controls, e.g., communication traffic and the like of the intra-company LAN 1.

The design department client computer 3a is used to search for component information used in the design department, the material department client computer 3b is used to search for component information used in the material department, and the production department client computer 3c is used to search for component information used in the production department.

The design department client computer 3a is a computer having a CAD system used to, e.g., manufacture a component.

The server computer 4 searches the databases 5a to 5d for component information stored therein on the basis of data that pertains to a component such as a model number or the like, which is input by the user to the client computer 3a (or client computer 3b or 3c), and outputs the found information that pertains to a component to the client computer 3a.

More specifically, the server computer 4 has a function that allows the client to use the distributed databases 5a to 5d as a single database.

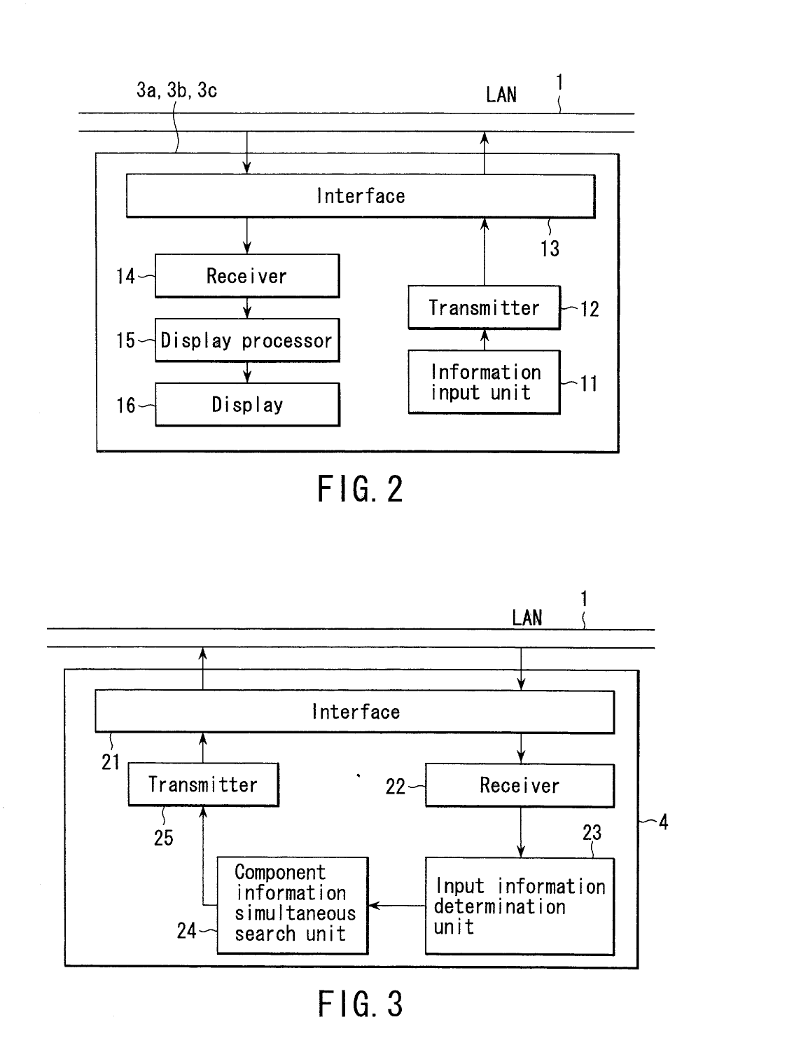

FIG. 2 is a functional block diagram of the client computers 3a to 3c of the component information database system of this embodiment.

As shown in FIG. 2, each of the client computers 3a to 3c comprises an information input unit 11, transmitter 12, interface 13, receiver 14, display processor 15, and display 16.

The information input unit 11 is used by the user to input at least one information that pertains to a component he or she wants to find out, e.g., a manufacturer model number, component code, or the like of the component, and comprises a keyboard or the like input by the user.

The transmitter 12 executes a data process of at least one information which is input from the information input unit 11, and pertains to a component that the user wants to search for so as to allow transmission of that information to the server computer 4, and outputs to the interface 13 at least one information which has undergone the data process and pertains to a component that the user wants to search for.

The interface 13 outputs to the server computer 4 via the intra-company LAN 1 at least one information which has undergone the data process, is output from the transmitter 12, and pertains to a component that the user wants to find out by a search.

On the other hand, the receiver 14 receives information which is output from the server computer 4 and pertains to a component that the user wants to search for via the interface 13, and outputs to the display processor 15 the information which pertains to a component that the user wants to search for.

The display processor 15 executes a data process of the information which is output from the receiver 14 and pertains to a component so as to allow display of it on the display 16, and outputs the information to the display 16.

The display 16 displays the information which is output from the display processor 15 and pertains to a component.

FIG. 3 is a functional block diagram of the server computer 4 of the database system of this embodiment.

As shown in FIG. 3, the server computer 4 comprises an interface 21, receiver 22, input information determination unit 23, component information simultaneous search unit 24, and transmitter 25.

The interface 21 receives at least one information which is output from the client computer 3a (3b or 3c) and pertains to a component from the intra-company LAN 1, and outputs it to the receiver 22. The receiver 22 outputs to the input information determination unit 23 at least one information which is received via the interface 21 and pertains to a component.

The input information determination unit 23 determines which of databases stores at least one information which is output from the receiver and pertains to a component.

The component information simultaneous search unit 24 searches the database determined by the input information determination unit 23, acquires information which contains key information (a component number in this embodiment) and pertains to a component, and searches other databases using the acquired key information for all pieces of information that pertains to a component.

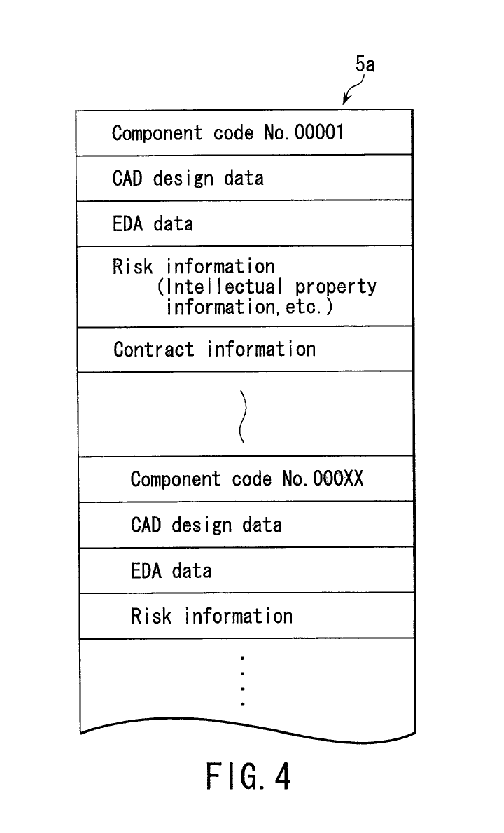

FIG. 4 shows data stored in the design department information database 5a.

As shown in FIG. 4, the design department information database 5a stores CAD design data, EDA data, risk information such as intellectual property information or the like, and contract information for respective component codes.

Note that the risk information in the design department that must be taken care of upon designing a component, and contains the presence/absence of pertinent intellectual properties, the presence/absence of self-company applications, the terms of intellectual properties, another's right information, image information of intellectual properties, and the like.

Also, some of these kinds of risk information may have levels as long as such levels can be assigned. For example, as for the presence/absence of self-company applications of the risk information, level “A” may be assigned to a case wherein the component of interest has already been filed by the self company; “B”, a case wherein the component of interest is in preparation for filing; “C”, a case wherein the component of interest is not proposed; and “D”, a case wherein the component of interest need not be filed, as shown in FIG. 9.

As for another's right information, as shown in FIG. 10, high notice level “A” may be assigned to a case wherein the component of interest is highly likely to interfere with another's rights; middle notice level “B”, a case wherein the component of interest is less likely to interfere with another's rights; and low notice level “C”, a case wherein the component of interest is unlikely to interfere with another's rights.

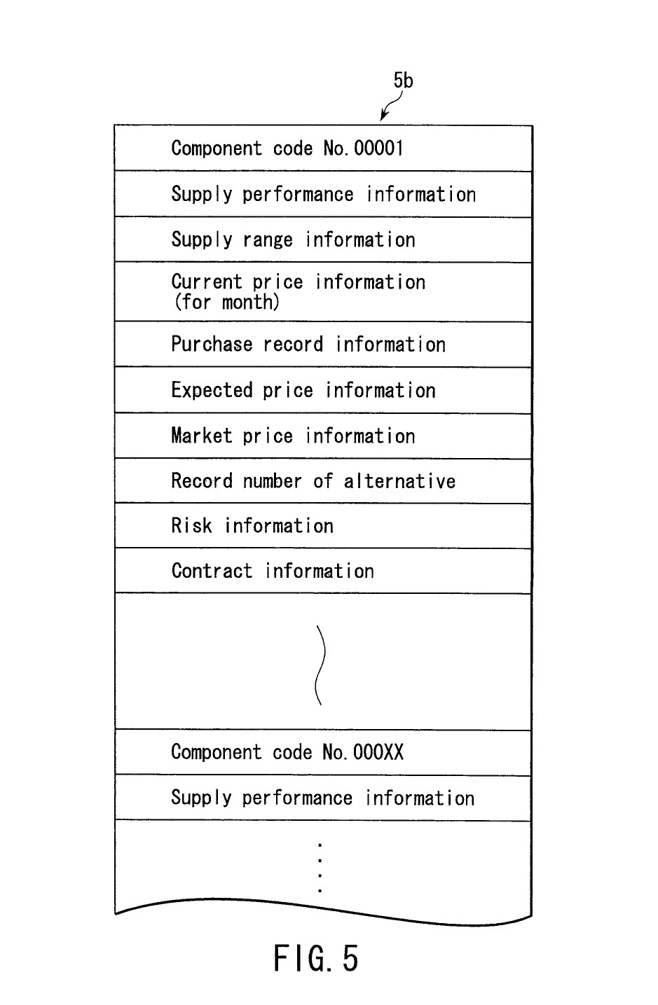

FIG. 5 shows data in the material department component information database 5b.

As shown in FIG. 5, the material department component information database 5b stores supply performance information, supply range, current price information of each month, purchase record information, expected price information, market price information, record numbers of alternatives, risk information, contract information, and the like for each component code.

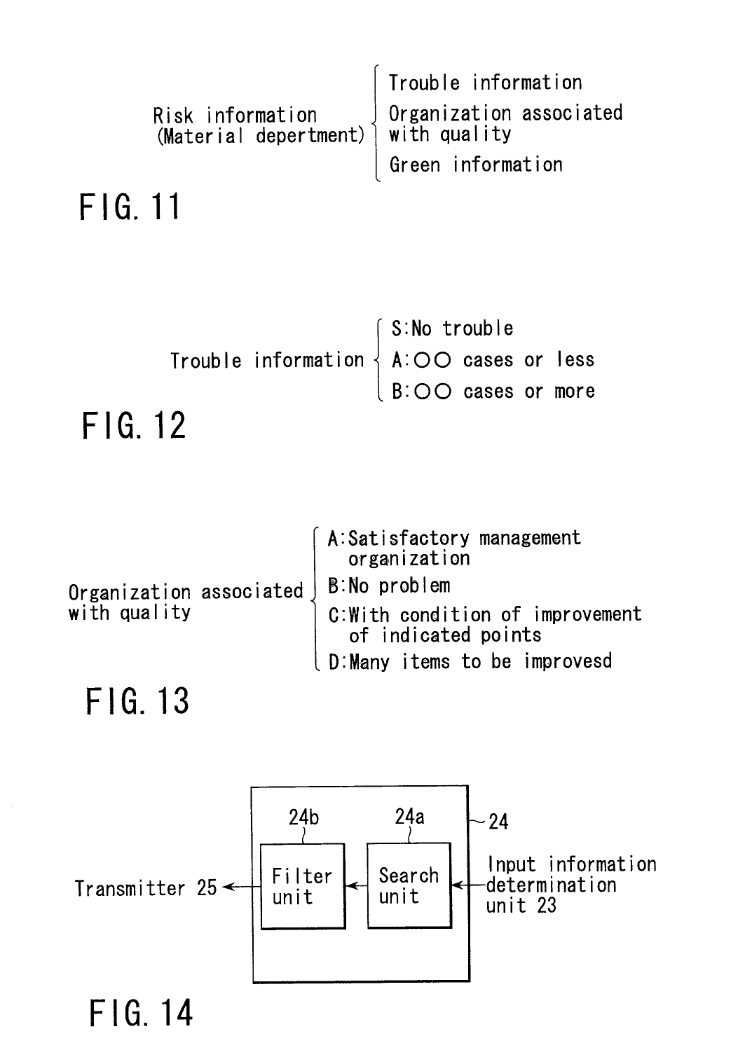

Note that the risk information in the material department is information that must be taken care of upon supplying materials, and contains trouble information, an organization associated with quality, green information, and the like, as shown in FIG. 11.

Also, some of these kinds of risk information may have levels as long as such levels can be assigned. For example, as for the trouble information of the risk information, level “S” may be assigned to a case wherein there is no trouble; “A”, a case wherein the number of troubles is equal to or smaller than ◯◯ cases; and “B”, a case wherein the number of troubles is equal to or larger than ◯◯ cases, as shown in FIG. 12.

As for the organization associated with quality, rank “A” may be assigned to a case wherein the management organization of the component of interest is satisfactory; “B”, a case wherein the management organization has no problem; “C”, a case with a condition that some indicated points must be improved; and “D”, a case wherein there are many items to be improved, as shown in FIG. 13.

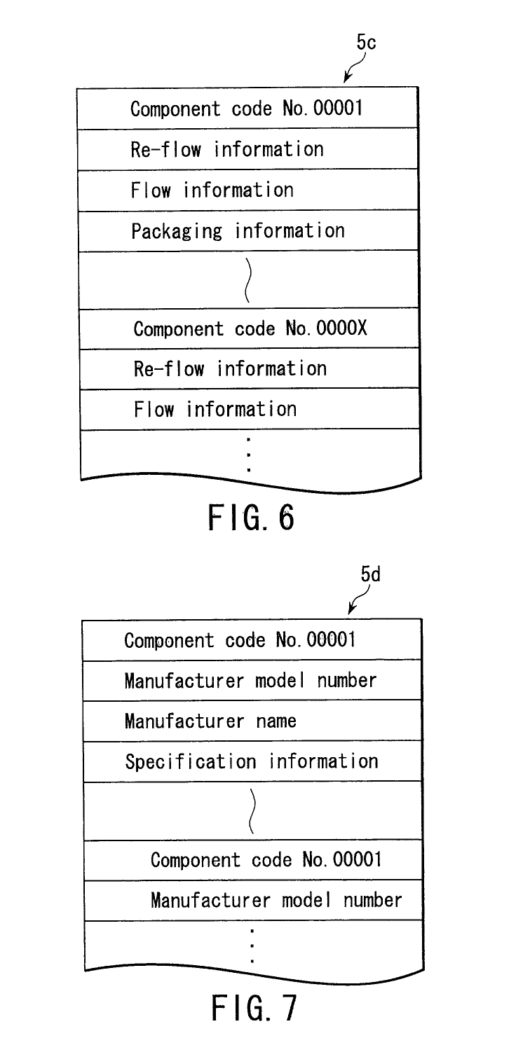

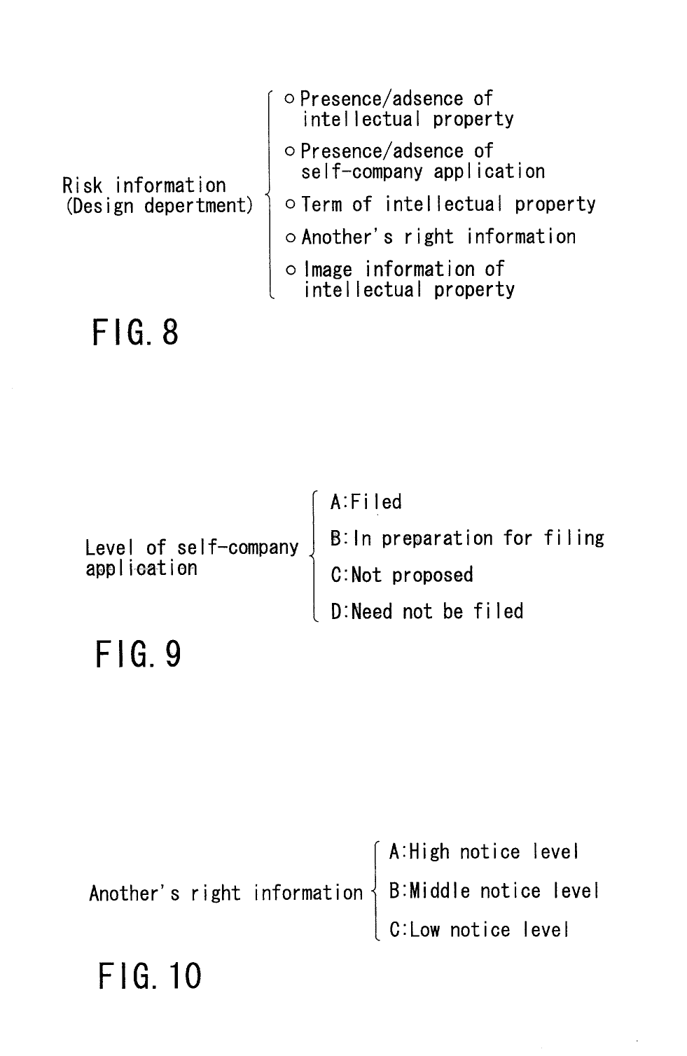

FIG. 6 shows data stored in the production department component information database 5c.

As shown in FIG. 6, the production department component information database 5c stores re-flow information, flow information, packaging information, and the like for each component code.

FIG. 7 shows data stored in the basic data database 5d.

As shown in FIG. 7, the basic data database 5d stores manufacturer model numbers, manufacturer names, specification information, and the like for respective component codes.

Note that data stored in the basic data database 5d are extracted from the component manufacturer database 9 via the intra-company LAN 1 and Internet 8 shown in FIG. 1.

If the type of information determined by the input information determination unit 23 is a manufacturer model number, the component information simultaneous search unit 24 searches the basic data database 5d to acquire information that pertains to the manufacturer model number (component code, manufacturer name, specification information), and acquires key information (component code number in this embodiment) upon detecting a plurality of databases.

The unit 24 searches other databases, i.e., the design department component information database 5a, material department component information database 5b, and production department component information database 5c on the basis of the acquired key information to acquire information associated with the component code information as the key information, and outputs the acquired information to the transmitter 25.

When not all pieces of acquired information that pertain to a component are required, for example, when only information that pertains to design is required in the design department, a filter unit 24b for extracting only required information from all pieces of information that pertain to a component found by the component information simultaneous search unit 24 may be provided, as shown in FIG. 14.

This filter unit 24b may use various filtering methods. In this embodiment, if a request of information that pertains to a component is received from the design department, a pre-setup may be made to extract information from only the design department component information database 5a and basic data database 5b.

In this case, the input information determination unit 23 determines a department of a client computer from which a request of information that pertains to a component is issued, and the filter unit 24b executes a filter process of a plurality of pieces of acquired information that pertain to a component on the basis of the determination result.

The transmitter 25 executes a data process of information which is output from the component information simultaneous search unit 24 and pertains to a component so as to allow transmission to the client computers 3a to 3c, and then outputs the information to the interface 21.

The interface 21 outputs the information which is output from the transmitter 25 and pertains to a component to the corresponding one of the client computers 3a to 3c as the request source via the intra-company LAN 1.

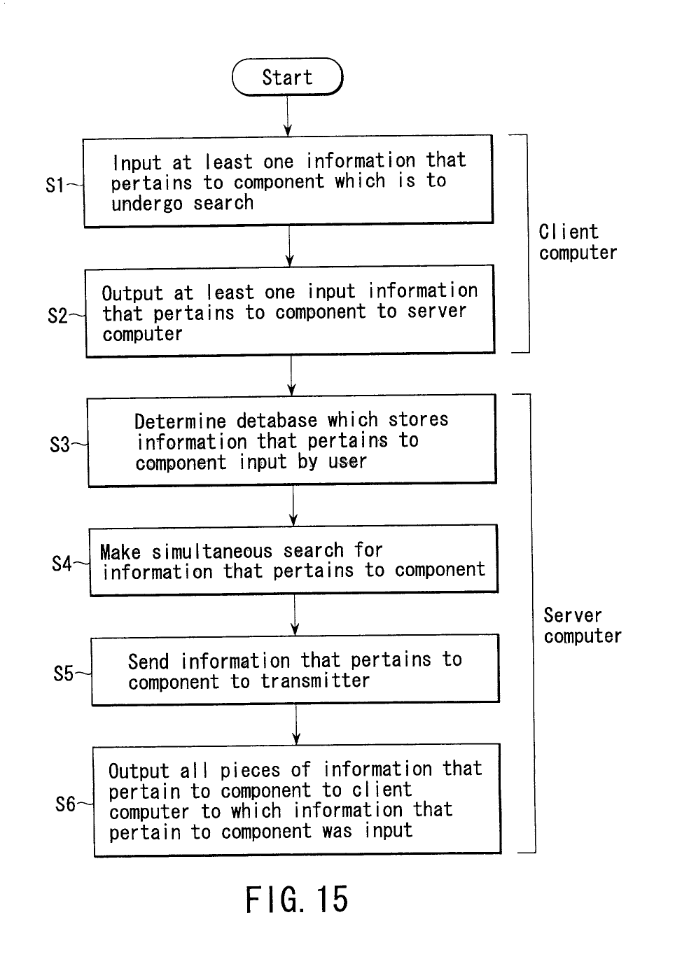

The operation of the component information database system according to this embodiment will be described below with reference to the flow chart shown in FIG. 15.

Assume that the user of the design department client computer 3a inputs at least one information which pertains to a component that he or she wants to search for, e.g., manufacturer model number information from the information input unit 11 of the design department client computer 3a (S1).

Note that the input method at the information input unit 11 may use a keyboard or selection from a menu displayed on a display, and the information input method is not particularly limited.

The manufacturer model number information input from the information input unit 11 of the design department client computer 3a undergoes a predetermined data process of the transmitter 12 to allow transmission to the server computer 4, and is then output to the server computer 4 via the interface 13 and intra-company LAN 1 (S2).

The manufacturer model number information output from the design department client computer 3a to the server computer 4 is input to the input information determination unit 23 via the interface 21 and receiver 22. The input information determination unit 23 determines which of databases stores the manufacturer model number information (S3). In this embodiment, since the manufacturer model number is stored in the basic data database 5d, the unit 23 recognizes the basic data database 5d.

The component information simultaneous search unit 24 searches the basic data database 5d recognized by the input information determination unit 23 on the basis of the manufacturer model number, and simultaneously searches other databases on the basis of a component code as key information found by the former search.

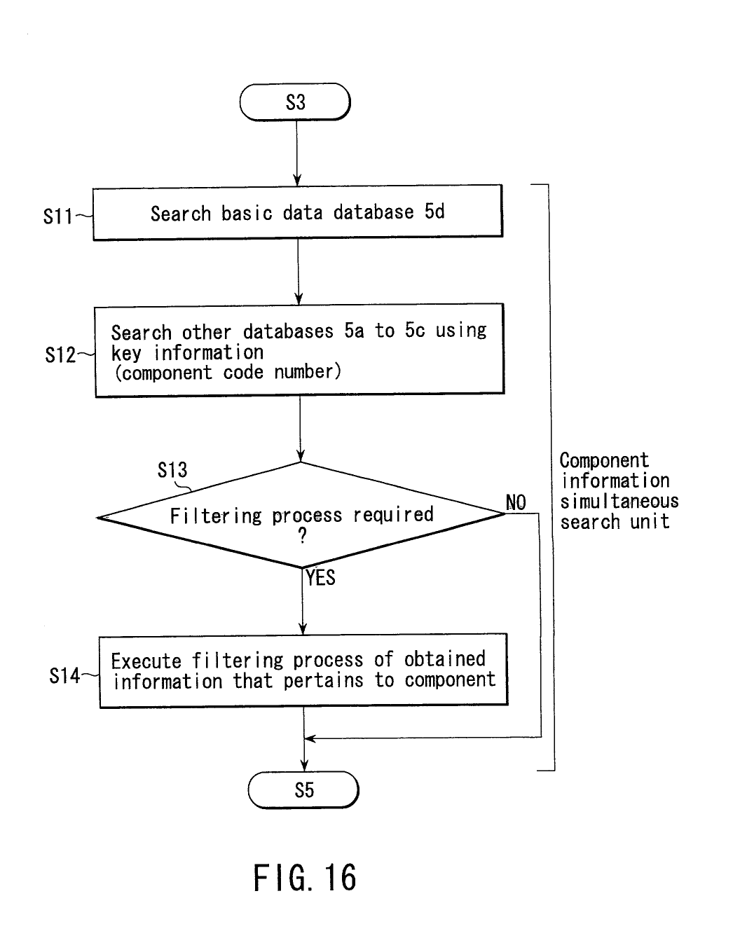

FIG. 16 is a flow chart for explaining details of the component information simultaneous search operation in step S4.

Since the input information determination unit 23 has recognized the basic data database 5d, the search unit 24 searches the basic data database 5d based on the input manufacturer model number to obtain a plurality of pieces of information associated with this manufacturer model number (component code number, manufacturer name, and specification information) (S11).

The search unit 24 searches the design department component information database 5a, material department component information database 5b, and production department component information database 5c in turn using the component code number as key information of the plurality of pieces of information obtained in step S11 (S12). In this way, all pieces of information that pertain to a component of the input model number shown in FIGS. 4 to 7 are obtained.

It is checked if a filtering process of the information pertaining to the component obtained in step S12 is required (S13).

If it is determined in step S13 that the filtering process is required, one or a plurality of pieces of information other than those designated by the user of the plurality of pieces of information that pertain to the component found by the simultaneous search undergo a filtering process and are removed (S14).

The user in the design department often does not require information of the material department and the like. In such case, when the user determines information he or she wants as those which pertain to the design department component information database 5a and basic data database 5d, information acquired from the material department component information database 5b and production department component information database 5c can be excluded by filtering. On the other hand, if it is determined in step S13 that no filtering process is required, the flow jumps to step S5.

In step S5, the component information simultaneous search unit 24 outputs the found information that pertains to the component to the transmitter 25. The transmitter 25 outputs the information which is obtained by the component information simultaneous search unit 24 and pertains to the component to the design department client computer 3a as a client computer at which the information was input (S6).

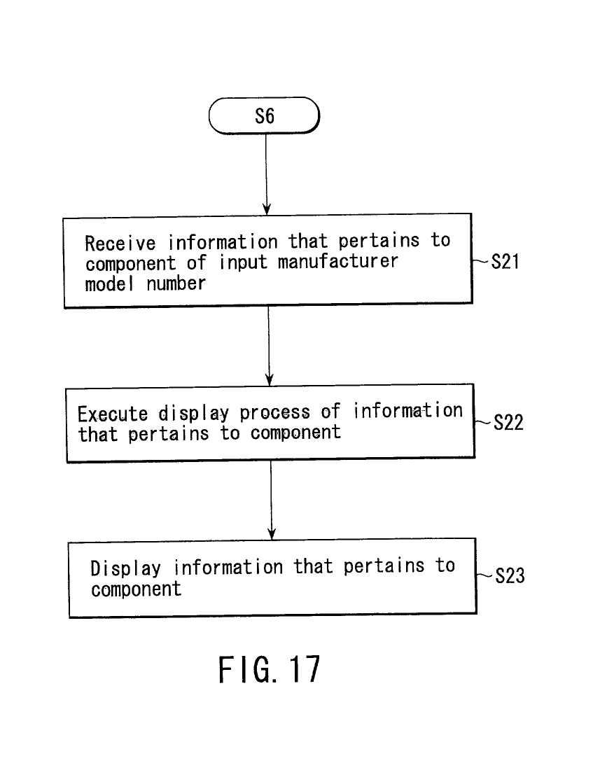

FIG. 17 is a flow chart for explaining a process after the information which is output from the server computer 4 and pertains to a component is received by the design department client computer.

In step S21, the receiver 14 receives the information which is output from the server computer 4 and pertains to a component. The display processor 15 executes a display process of the information which is received by the receiver 14 and pertains to a component (S22). The display 16 displays the information which has undergone the display process in the display processor 15 and pertains to a component (S23).

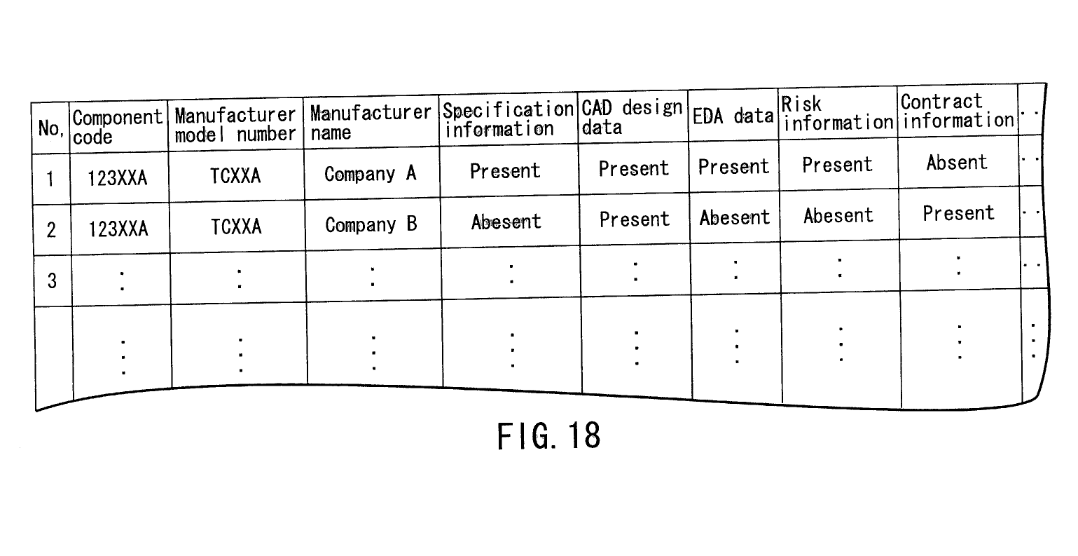

FIG. 18 shows a display screen displayed on the display 16 of the design department client computer 3a.

As shown in FIG. 18, a plurality of pieces of information that pertain to components corresponding to the manufacturer model number input at the design department client computer 3a are displayed on the screen. Note that FIG. 18 shows only data acquired from the design department component information database 5a and basic data database 5d. When all data acquired from the design department component information database 5a, material department component information database 5b, production department component information database 5c, and basic data database 5d are sent from the server computer 4 without any filtering process, all the data may be displayed.

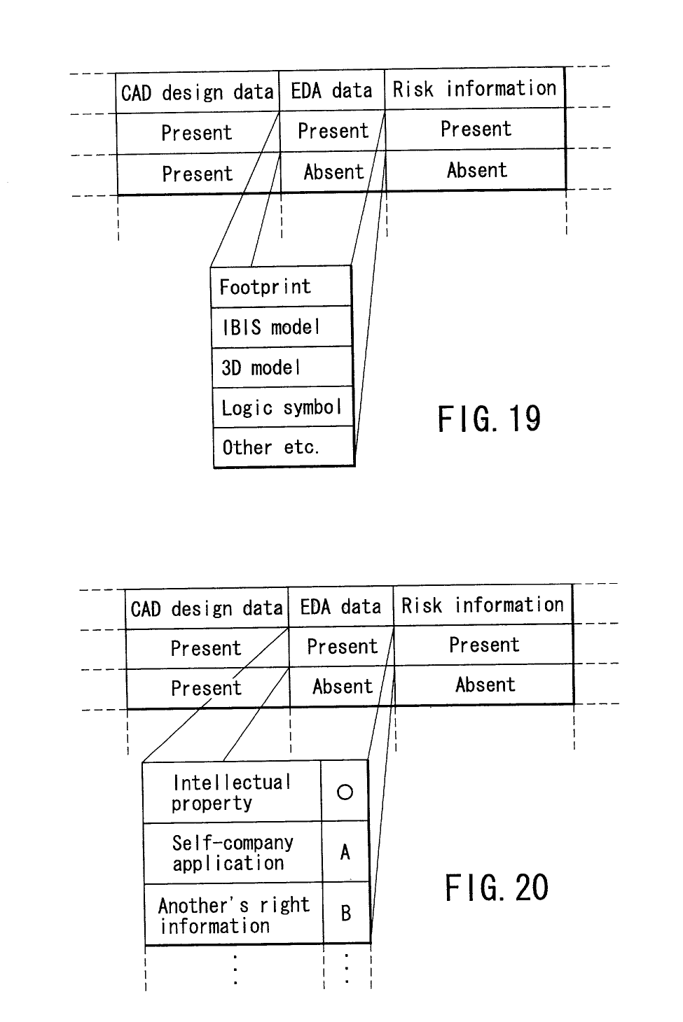

When the user clicks a field of EDA data of component number 1 on the screen shown in FIG. 18 by a pointing device such as a mouse or the like, the types of EDA data shown in FIG. 19 are displayed. When the user then clicks a window that displays the types of EDA data, a corresponding window is displayed.

For example, when the user clicks a field of “3D model” on the window that displays the types of EDA data shown in FIG. 19, a 3D model of a corresponding component is displayed. Note that all these data are contained in EDA data stored in the design department component information database 5a.

On the other hand, when the user clicks a field of risk information of component number 1 on the screen shown in FIG. 18 by a pointing device such as a mouse or the like, risk information is displayed, as shown in FIG. 20.

In FIG. 20, self-company application information and another's right information are ranked. Since the self-company application information is assigned rank “A”, the user can recognize that this component has been filed. Note that this rank has been explained previously with reference to FIG. 9.

Since the another's right information is assigned rank “B”, the user can recognize that notice level is “middle” in association with another's rights. Note that this rank has been explained previously with reference to FIG. 10.

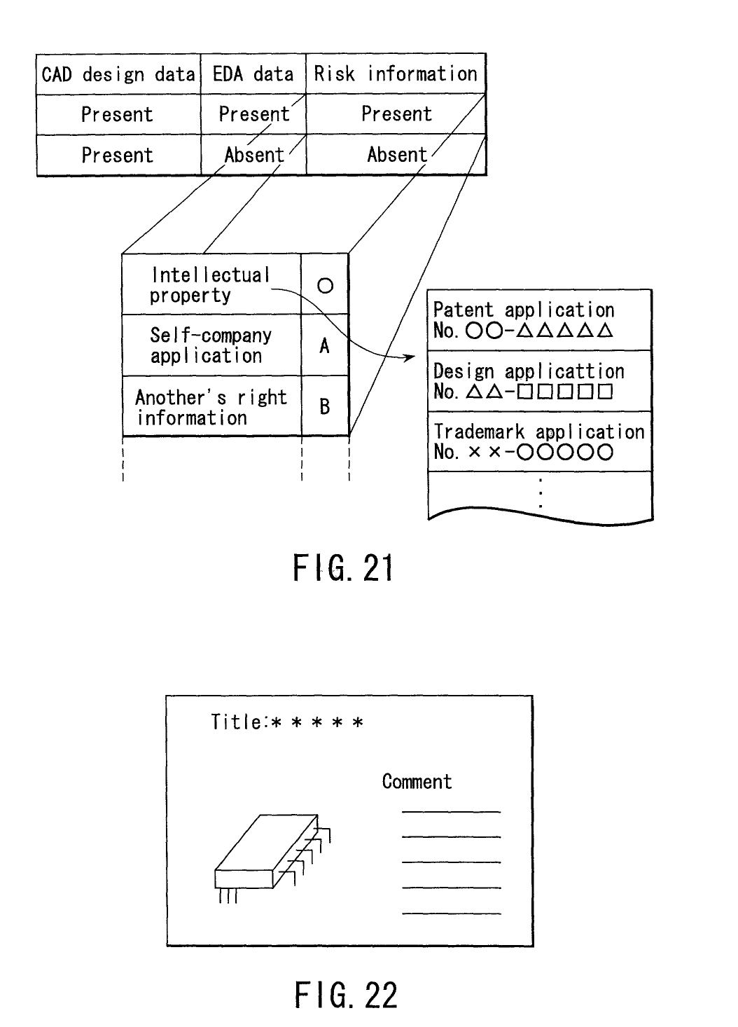

Furthermore, when the user clicks a field of intellectual properties in FIG. 20, intellectual property information acquired for this component is displayed, as shown in FIG. 21.

When the user clicks the displayed intellectual property information, an image window of the intellectual property information is displayed, as shown in FIG. 22. Note that FIG. 22 shows an image upon clicking patent application Ser. No. ◯◯-ΔΔΔΔ. For example, this image window uses an image of an abstract for a patent, utility model, and design.

Note that the display screen is switched in such way by an application program of each of the client computers 3a to 3c.

In the above description, the manufacturer model number is input from the design department client computer 3a. Also, when information that pertains to a component is input from the remaining material department client computer 3b and production department client computer 3c, the server computer 4 searches all the databases 5a to 5c, and all pieces of found information or those after the filtering process are displayed.

Therefore, according to the component information database of this embodiment, risk information such as intellectual properties (patent rights, design rights, and the like) is provided to components to be registered in a component information database, and reference to detailed information of risk information such as intellectual properties of respective components can be referred to as images, so as to evade invasion of another's rights and prevent troubles in a component adoption stage.

Since a plurality of pieces of information that are stored in a plurality of databases and pertain to a component are associated, those pieces of information can be simultaneously acquired and displayed.

<Another Embodiment>

A component information database system related to another embodiment of the present invention will be explained below.

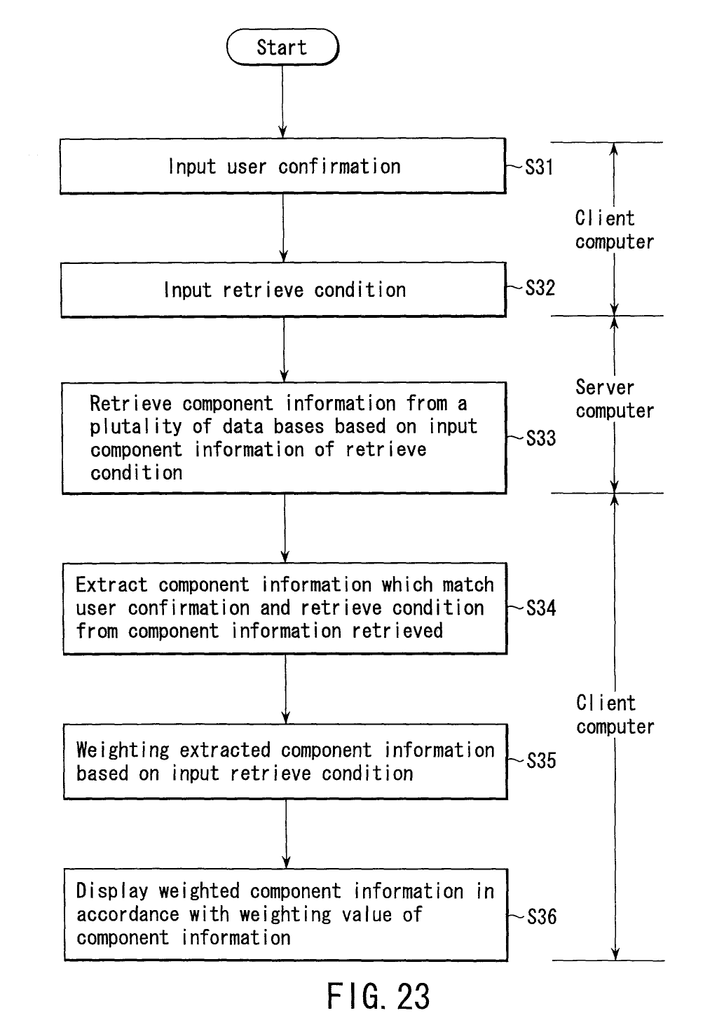

FIG. 23 is a flowchart to explain operation of the database system related to another embodiment of the present invention. At first, as shown in the figure above, input of user confirmation is done (S31). For example, with user confirmation, information indicating property of users such as the design department, material department, and manufacturing department is input. In this case, it is assumed that the material department is input as example here.

A retrieve condition is input next (S32). For example, the retrieve condition includes the component information including component information code, manufacture model number and risk information, and also includes a condition of time for delivery in the material department and a condition of volume of production.

As a retrieve condition, it is assumed that a condition of “time for delivery is less than 10 days” is input other than the component information.

Next, based on one of component information input as a retrieve condition, other component information are retrieved from plural databases (S33). Retrieval method of this other component information is similar to that of the embodiment described above.

Next, component information which matches the user confirmation and retrieve condition are retrieved from the retrieved component information (S34). It is assumed that information about time for delivery is written in the risk information of component information stored in the material department.

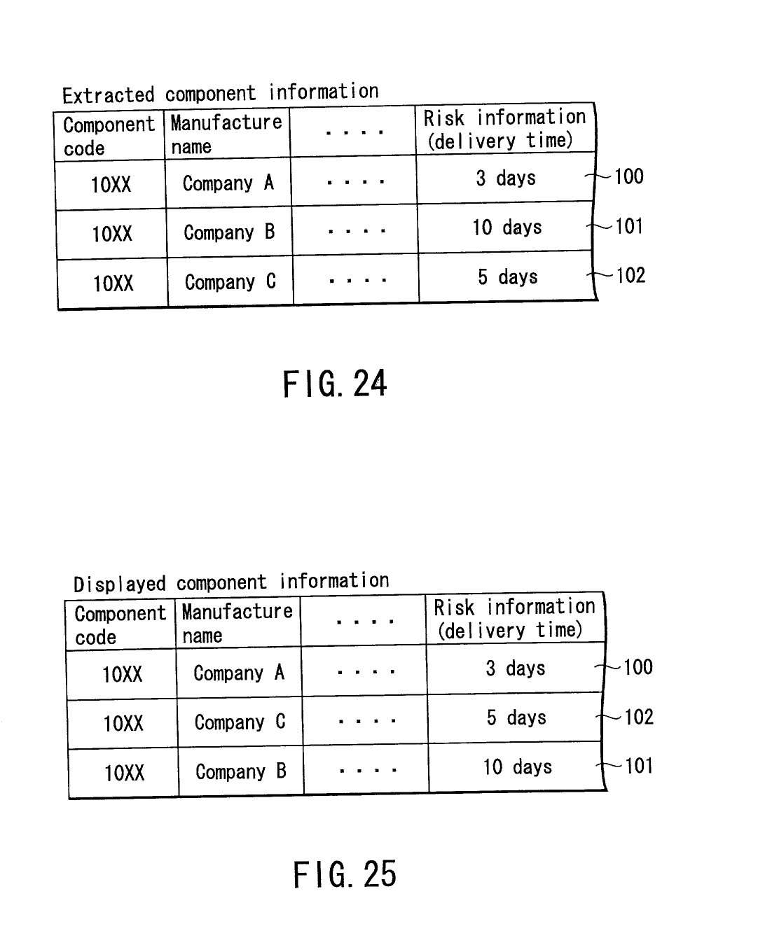

FIG. 24 shows the extracted component information. As shown in the figure above, component information 100 of A company that the time for delivery is 3 days, component information 101 of B company that the time for delivery is 10 days and component information 102 of the C company that the time for delivery is 5 days are extracted.

Next, weighting process is performed with respect to the extracted component information based on the input retrieve condition (i.e. time for delivery is 10 days) (S35). In example shown in FIG. 24, weighting value of component information 101 is most large (risk factor is large) and that of component information 100 is the smallest.

Based on the Weighted value of the component information, the weighted component information are displayed (S36). In this case, the weighted component information are displayed in increasing order of the weighting value. FIG. 25 shows display example of search results.

Therefore, according to the database system of this embodiment, since, weighting the component information in accordance with the retrieve condition, the retrieve results are displayed based on the weighted value, a user can show most appropriate component information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A search method of a component information database system, comprising:
inputting at least one of component information that include a component code, manufacturer model number, and risk information associated with a given component and a retrieve condition of the component information to be retrieved;
retrieving component information including a component code, manufacturer model number, and risk information associated with a given component from a plurality of data bases based on the input component information;
extracting component information which match the retrieve condition from the retrieved component information including a component code, manufacturer model number, and risk information associated with a given component; and
displaying the extracted component information including the risk information.

2. A method according to claim 1, wherein when a user designates the displayed risk information, information indicating a presence/absence of pertinent intellectual properties acquired for the designated component is displayed on the basis of the component information which are retrieved from the plurality of databases.

3. A method according to claim 2, wherein when the user designates the displayed information indicating the presence/absence of pertinent intellectual properties, information indicating types of intellectual properties acquired for the designated component is displayed on the basis of the component information which are retrieved from the plurality of databases, and when the user designates the displayed information indicating types of intellectual properties, an image indicating contents of an intellectual property corresponding to the designated information indicating the types of intellectual properties is displayed on the basis of the input information which are retrieved from the plurality of databases.

4. A method according to claim 1,
wherein the risk information is weighted in accordance with a content thereof in advance and the step of displaying displays the extracted component information in decreasing order of the weighted value of the risk information.

5. A component information database system comprising:
a network;
a server computer connected to said network;
a client computer connected to said network; and
a plurality of databases which are connected to at least one of said network and said server computer, and store component information that include a component code, manufacturer model number, and risk information associated with a given component,
wherein the client computer comprises:
means for confirming a user class;
means for inputting a retrieve condition for acquiring the component information; and
means for transmitting the retrieve condition to the server computer,
the server computer further comprises:
means for receiving the retrieve condition transmitted from the client computer;
means for extracting the component information which match the retrieve condition from the plurality of databases; and
means for transmitting the component information extracted to the client computer, and
the client computer further comprises:
means for receiving the component information transmitted from the server computer; and
means for extracting the component information corresponding to the user class from the component information received and displaying the component information extracted.

6. A system according to claim 5, wherein the risk information is weighted in accordance with a content thereof in advance and the display means the extracted component information in decreasing order of the weighted value of the risk information.

7. A component information database system comprising:
means for inputting at least one of component information that include a component code, manufacturer model number, and risk information associated with a given component and a retrieve condition of component information to be retrieved;
means for retrieving component information including a component code, manufacturer model number, and risk information associated with a given component based on the input component information;
means for extracting component information which match the retrieve condition from the retrieved component information including a component code, manufacturer model number, and risk information associated with a given component; and
means for displaying the extracted component information including the risk information.

8. A system according to claim 7, wherein when a user designates the risk information displayed by said display means, said display means displays information indicating a presence/absence of pertinent intellectual properties acquired for the designated component on the basis of the plurality of kinds of information which are found by search and pertain to the component.

9. A system according to claim 8, wherein when the user designates the information indicating the presence/absence of pertinent intellectual properties, said display means displays an image indicating contents of an intellectual property acquired for the designated component on the basis of the plurality of kinds of information which are found by searching the plurality of databases and pertain to the component.

10. A system according to claim 7,
wherein the risk information is weighted in accordance with a content thereof in advance and the display means displays the extracted component information in decreasing order of the weighted value of the risk information.
